(19) United States
(12) Patent Application Publication
(10) Pub. No.: US 2008/0086590 A1
(43) Pub. Date: Apr. 10, 2008

(54) Flash Memory Control Interface

(76) Inventor: Masayuki URABE, Isehara City (JP)

Correspondence Address: THE LAW OFFICES OF ANDREW D. FORTNEY, PH.D., P.C., 401 W. FALLBROOK AVENUE, SUITE 204, FRESNO, CA, 93711-5835, US

(21) Appl. No.: 11/866,176

(22) Filed: Oct. 2, 2007

Related U.S. Application Data
(60) Provisional application No. 60/828,144, filed on Oct. 4, 2006.

(51) Int. Cl. G06F 12/02

(52) U.S. Cl. 711/103; 711/E12.008

(57) ABSTRACT

Interfaces, arrangements, and methods for controlling flash memory devices in a multiple device system without increasing the pin count are disclosed. In one embodiment, the system includes first and second flash memory devices and a memory controller. The first memory device receives a configuration signal from a memory controller, and generates a registered signal from the configuration signal for the second memory device. The registered signal may also be provided to the memory controller from a last of the multiple memory devices. The memory controller communicates with the memory devices via an interface that includes a plurality of parallel input/output (I/O) terminals coupled to each of memory device and a serially-connected control terminal. The parallel I/O terminals generally include one or more data I/O terminals configured to transmit data (including parametric data) and commands, a clock terminal configured to receive a clock signal, and a write protect terminal configured to receive a write protection signal.

### RELATED APPLICATION(S)

This application claims the benefit of U.S. Provisional Application No. 60/798,630 (Attorney Docket No. MP1313PR), filed on Oct. 4, 2006, incorporated herein by reference in its entirety.

### FIELD OF THE INVENTION

The present invention generally relates to the field of flash memory devices, interfaces and architectures. More specifically, embodiments of the present invention pertain to an interface, arrangement, and method for controlling flash memory devices.

### DISCUSSION OF THE BACKGROUND

Memory devices, such as flash electrically erasable programmable read only memory (EEPROM), are becoming more widespread. For example, “jump” drives (e.g., for universal serial bus (USB) connections), memory cards, and other nonvolatile memory applications are commonplace in cameras, video games, computers, and other electronic devices. FIG. 1 shows a block diagram of a conventional memory array organization 100. For example, the memory array can be organized in bits (e.g., 8-bit depth 108), bytes (e.g., 2 kB portion 104, and 64B portion 106), pages (e.g., 512K pages 102, corresponding to 8192 blocks), and blocks (e.g., block 110, equal to 64 pages), forming an 8 Mb device in this particular example. Also, single page 112 can be organized as portion 114 (e.g., 2 kB+64B=2112B=840 h), and portion 116, corresponding to an eight (8)-bit wide data input/output (I/O) path (e.g., I/O 0-1/O 7).

This type of flash memory may represent a “NAND” type, which typically has faster erase and write times, higher density, lower cost per bit, and more endurance than a “NOR” type flash memory. However a NAND flash I/O interface typically allows only sequential access to data.

Referring now to FIG. 2A, a timing diagram showing a conventional read operation is indicated by the general reference character 200. As shown below in Table 1, various pin functions can correspond to designated pins in a NAND flash interface.

TABLE 1

| PIN | PIN FUNCTION |
|---|---|
| I/O[7:0] | Data in/out |
| CLE | Command latch enable |
| ALE | Address latch enable |
| CE_{—} | Chip enable |
| RE_{—} | Read enable |
| WE_{—} | Write enable |
| WP_{—} | Write protect |
| R/B_{—} | Ready/busy output |

In FIG. 2A, WE_ can be pulsed (e.g., at a 25 ns period) to allow row address (e.g., RA1, RA2, and RA3) and column address (e.g., CA1 and CA2) information to be latched in the device. Command “00h” may indicate a read address input, while command “30h” may indicate a read start, as shown. With RE_pulsing, data Dₒᵤₜ N, Dₒᵤₜ N+1, Dₒᵤₜ N+2, . . . Dₒᵤₜ M can be read from the device. Also, signal R/B_ in a low logic state can indicate a busy state on the output, and R/B_ may go high some period of time after the last rising edge of WE_, for example. Row and column address multiplexing on the data in/out pins (e.g., I/O[7:0]) can be as shown below in Table 2.

TABLE 2

| CYCLE | I/O[0] | I/O[1] | I/O[2] | I/O[3] | I/O[4] | I/O[5] | I/O[6] | I/O[7] |
|---|---|---|---|---|---|---|---|---|
| 1^{st} Cycle: | A0 | A1 | A2 | A3 | A4 | A5 | A6 | A7 |
| Column Address | | | | | | | | |
| 2^{nd} Cycle: | A8 | A9 | A10 | A11 | L | L | L | L |
| Column Address | | | | | | | | |
| 3^{rd} Cycle: | A12 | A13 | A14 | A15 | A16 | A17 | A18 | A19 |
| Row Address | | | | | | | | |
| 4^{th} Cycle: | A20 | A21 | A22 | A23 | A24 | A25 | A26 | A27 |
| Row Address | | | | | | | | |
| 5^{th} Cycle: | A28 | A29 | A30 | L | L | L | L | L |
| Row Address | | | | | | | | |

For example, higher address bits can be utilized for addressing larger memory arrangements (e.g., A30 for 2 Gb, A31 for 4 Gb, A32 for 8 Gb, A33 for 16 Gb, A34 for 32 Gb, and A35 for 64 Gb).

Referring now to FIG. 2B, a timing diagram showing a conventional page program operation is indicated by the general reference character 220. Here, command “80h” can indicate serial data (e.g., Dᵢₙ N . . . Dᵢₙ M) input. Command “10h” can indicate an auto program, followed by a status read (command “70h”). I/O[0]=“0” can indicate no error condition, while I/O[0]=“1” may indicate that an error in auto programming has occurred. Also, signal R/B_ may be low, indicating a busy state, for a length of time typically on the order of hundreds of μs. Also, a rising edge of RE_ can trail a rising edge of WE_ by a period of time (60 ns, in one example).

FIG. 2C shows a timing diagram 240 for a conventional block erase operation. Here, command “60h” can indicate a block erase operation, with sequential row addresses (e.g., RA1, RA2, and RA3) supplied. Command “D0h” can indicate a cycle 2 block erase operation. The block erase operation can be checked by a status read (command “70h”), where I/O[0]=“0” can indicate no error condition, while I/O[0]=“1” may indicate that an error in block erase has occurred. Example signal times can include signal R/B_ being low for a period of time typically on the order of about a millisecond (with a predetermined maximum), a rising edge of RE_ trailing a rising edge of WE_, and a rising edge of WE_ corresponding to the D0h command to a falling edge of R/B_ of about 100 ns.

In conventional flash memory arrangements involving multiple chips or devices in a common package (e.g., a hybrid drive), multiple chip enable (CE_) pins may be required to access the various flash memory chips. Particularly in larger memory structures, such multiple enable pins may result in relatively complicated control logic and consume a relatively large chip area. Therefore, it would be desirable to provide a solution that is able to control access to (e.g., programming and reading) multiple flash memory chips or devices without increasing the pin count.

### SUMMARY OF THE INVENTION

Embodiments of the present invention pertain to an interface, arrangement, and method for controlling flash memory devices. In one aspect, a method of configuring a multi-device memory system comprises asserting a control signal to a plurality of flash memory devices, determining a unique identifier for each of the plurality of flash memory devices, and serially storing the unique identifier in a corresponding one of the plurality of flash memory devices within a predetermined number of clock cycles of asserting the control signal. Each flash memory device in the system has a plurality of parallel input and/or output (I/O) terminals and a serially-connected control terminal configured to receive the control signal. The parallel I/O terminals include one or more data I/O terminal(s), a clock terminal configured to receive a clock signal, and a write protect terminal configured to receive a write protection signal. The parallel I/O terminal(s) may further comprise a command control input terminal for receiving a command timing signal, an interrupt terminal for transmitting an interrupt signal from an identified flash memory device, and/or a read clock output terminal for transmitting a read sampling clock from an identified flash memory device to a memory controller. The number of flash memory devices to be configured may be determined using a time-shifted version of the control signal, received from the last flash memory device. Typically, the unique identifier comprises a multi-bit binary string. In further embodiments, each unique identifier may be serially stored in a reserved memory portion in the corresponding one of the plurality of flash memory devices, and/or the method may further comprise reading each unique identifier from each of the plurality of flash memory devices.

In various embodiments of the method, the control signal may be a configuration control signal and the control signal is asserted when it has a predetermined state or undergoes a predetermined transition. In one implementation, the control signal is asserted for about one clock cycle. The method may further involve sending and/or receiving commands, such as a device configuration command that may control certain memory device configuration operations in the system. For example, one command may comprise reading the unique identifier from one or more (e.g., each) of the flash memory devices.

In further embodiments, the method may further comprise time-shifting the control signal using the clock signal in a first flash memory device and providing a shifted control signal to a second flash memory device adjacent to the first flash memory device. In one variation, the unique identifier may be determined by providing parametric data through the data I/O terminal(s) for each of the plurality of flash memory devices, and/or by registering and/or storing at least a portion of the parametric data for each of the plurality of flash memory devices using the clock signal. A time-shifted version of the configuration control signal from an adjacent one of the plurality of flash memory devices may be used for registering the parametric data. Alternatively, the unique identifier may be determined by storing at least a portion of the registered parametric data as the unique identifier, and/or counting a number of clock cycles between a first command and a time-shifted version of the configuration signal.

In the present method of configuring memory devices, the control signal can be ignored in one of the flash memory devices when the flash memory device has stored the unique identifier without being reset, the write protection signal is asserted, and/or the control signal is asserted for a predetermined number of clock cycles. In one implementation, the predetermined number is greater than one. Also, each unique identifier may be stored in a reserved memory portion in the flash memory device.

Another aspect of the invention relates to a method of operating a multi-device memory system comprising asserting one or more control signals on a corresponding number of serially-connected I/O terminals on each of a plurality of flash memory devices in the system, identifying one of the flash memory devices by transmitting a unique identifier on data I/O terminal(s) within a predetermined number of clock cycles of asserting the control signal(s), and transmitting an instruction to the identified flash memory device on the data I/O terminal(s). Generally, each of the flash memory devices includes a plurality of parallel data I/O terminals and a clock terminal.

In various embodiments of the method of operating a multi-device memory system the instruction may further comprise a read, erase, or program command. Identifying the one of the memories may comprise supplying a device identification byte on the data I/O terminal(s). In certain implementations, the device identification byte is supplied in a clock cycle prior to transmitting the instruction, the clock signal being supplied on the clock terminal. The method of operating a multi-device memory system may further comprise synchronizing a result of the instruction using a read sampling clock coupled to each of the plurality of flash memory devices. In other implementations, the instruction may be transmitted across an interface coupling a memory controller to the plurality of flash memory devices, the interface comprising a configuration terminal for transmitting a configuration signal to a first of the plurality of flash memory devices, a command control terminal for transmitting a command timing signal to the plurality of flash memory devices, and/or a read clock terminal for receiving a read sampling clock from one of the plurality of flash memory devices.

The apparatus concerns a memory module, comprising a first flash memory device configured to receive a configuration signal from a memory controller and to generate a first registered signal from the configuration signal, a second flash memory device configured to receive the first registered signal and to generate a second registered signal from the first registered signal, and a memory controller coupled to the first and second flash memory devices via an interface. The interface comprises a control terminal configured to transmit the configuration signal and a plurality of parallel input/output (I/O) terminals coupled to each of the first and second flash memory devices. The plurality of parallel I/O terminals generally include one or more data I/O terminals configured to transmit the configuration signal and data signals, a clock terminal configured to receive a clock signal, and a write protect terminal configured to receive a write protection signal. In certain implementations, the data I/O terminals comprise at least eight bits. In further implementations, the parallel I/O terminal(s) may further include a command control input terminal for receiving a command timing signal, a read clock output terminal for transmitting a read sampling clock from an identified one of the plurality of flash memory devices to a memory controller, and/or an interrupt terminal for transmitting an interrupt signal from an identified one of the plurality of flash memory devices.

In various embodiments, the first and second registered signals are configured to serially shift a pulse of the configuration signal from the first to the second flash memory device, and then to the memory controller. Each of the first and second flash memory devices comprises a first D-type flip-flop configured to provide the first and second registered signals, respectively. Each of the first and second flash memory device optionally comprises a second D-type flip-flop configured to register parametric data when enabled by a corresponding one of the first and second registered signals, the parametric data being provided on the data I/O terminals. The parametric data may comprise a unique identifier.

In further embodiments, the memory module may further comprise counting logic, the counting logic being configured to compute a unique identifier from a number of clocks between a device configuration command and a corresponding one of the first and second registered signals. Additionally or alternatively, the controller may further comprise configuration logic configured to transmit the configuration signal to the first flash memory device, command control logic configured to transmit a command timing signal to the first and second flash memory devices, timing logic configured to transmit a clock signal to the first and second flash memory devices, and/or a read clock terminal configured to receive a read sampling clock from one of the plurality of flash memory devices. In one implementation, the command timing signal is configured to be de-asserted a predetermined number of clock cycles (e.g., one cycle) prior to disabling or tri-stating the data I/O terminals when providing the unique identifier.

The present invention advantageously provides an interface, arrangement, and method for configuring and operating flash memory devices in multiple device systems without increasing a pin count. These and other advantages of the present invention will become readily apparent from the detailed description of preferred embodiments below.

### BRIEF DESCRIPTION OF THE DRAWINGS

FIG. 1 is a block diagram showing a conventional memory array organization.

FIG. 2A is a timing diagram showing a conventional read operation.

FIG. 2B is a timing diagram showing a conventional page program operation.

FIG. 2C is a timing diagram showing a conventional block erase operation.

FIG. 3 is a block diagram showing an exemplary hybrid drive arrangement suitable for use in accordance with embodiments of the present invention.

FIG. 4 is a block diagram showing an exemplary signal connection arrangement in accordance with embodiments of the present invention.

FIG. 5 is a timing diagram showing an exemplary command sequence in accordance with embodiments of the present invention.

FIG. 6 is a block diagram showing an exemplary flash memory chip and memory controller arrangement in accordance with embodiments of the present invention.

FIG. 7 is a timing diagram showing an exemplary device configuration in accordance with embodiments of the present invention.

FIG. 8A is a timing diagram showing an exemplary erase operation in accordance with embodiments of the present invention.

FIG. 8B is a timing diagram showing an exemplary send buffer data to host read buffer operation in accordance with embodiments of the present invention.

FIG. 9 is a flow diagram showing an exemplary method of erasing in accordance with embodiments of the present invention.

FIGS. 10A-10G are diagrams showing exemplary systems in which the present invention may be used.

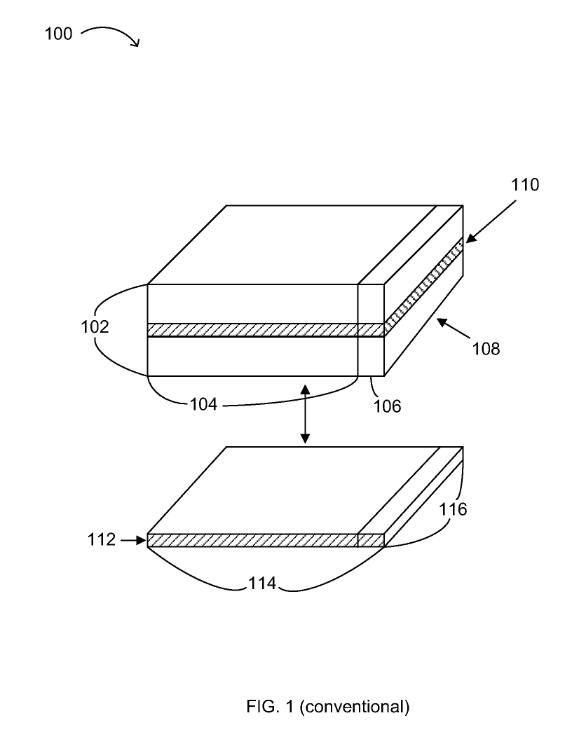

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents that may be included within the spirit and scope of the invention as defined by the appended claims. Furthermore, in the following detailed description of the present invention, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

Some portions of the detailed descriptions which follow are presented in terms of processes, procedures, logic blocks, functional blocks, processing, and other symbolic representations of operations on data bits, data streams or waveforms within a computer, processor, controller and/or memory. These descriptions and representations are generally used by those skilled in the data processing arts to effectively convey the substance of their work to others skilled in the art. A process, procedure, logic block, function, operation, etc., is herein, and is generally, considered to be a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and otherwise manipulated in a computer, data processing system, or logic circuit. It has proven convenient at times, principally for reasons of common usage, to refer to these signals as bits, waves, waveforms, streams, values, elements, symbols, characters, terms, numbers, or the like.

It should be borne in mind, however, that all of these and similar terms are associated with the appropriate physical quantities and are merely convenient labels applied to these quantities. Unless specifically stated otherwise and/or as is apparent from the following discussions, it is appreciated that throughout the present application, discussions utilizing terms such as “processing,” “operating,” “computing,” “calculating,” “determining,” “manipulating,” “transforming,” or the like, refer to the action and processes of a computer, data processing system, logic circuit or similar processing device (e.g., an electrical, optical, or quantum computing or processing device), that manipulates and transforms data represented as physical (e.g., electronic) quantities. The terms refer to actions, operations and/or processes of the processing devices that manipulate or transform physical quantities within the component(s) of a system or architecture (e.g., registers, memories, other such information storage, transmission or display devices, etc.) into other data similarly represented as physical quantities within other components of the same or a different system or architecture.

Furthermore, for the sake of convenience and simplicity, the terms “signal(s)” and “waveform(s)” may be used interchangeably, and in general, use of one such form generally includes the other, unless the context of the use unambiguously indicates otherwise; however, these terms are generally given their art recognized meanings. The terms “node(s)”, “input(s)”, “output(s)”, and “port(s)” may be used interchangeably, as may the terms “connected to”, “coupled with”, “coupled to”, and “in communication with” (which terms also refer to direct and/or indirect relationships between the connected, coupled and/or communicating elements, unless the context of the term's use unambiguously indicates otherwise). However, these terms are also given their art recognized meanings.

The invention, in its various aspects, will be explained in greater detail below with regard to exemplary embodiments.

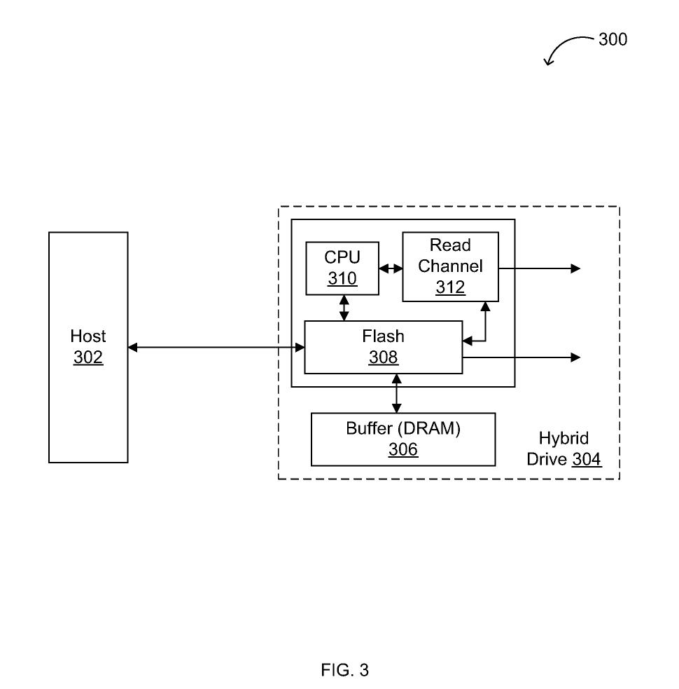

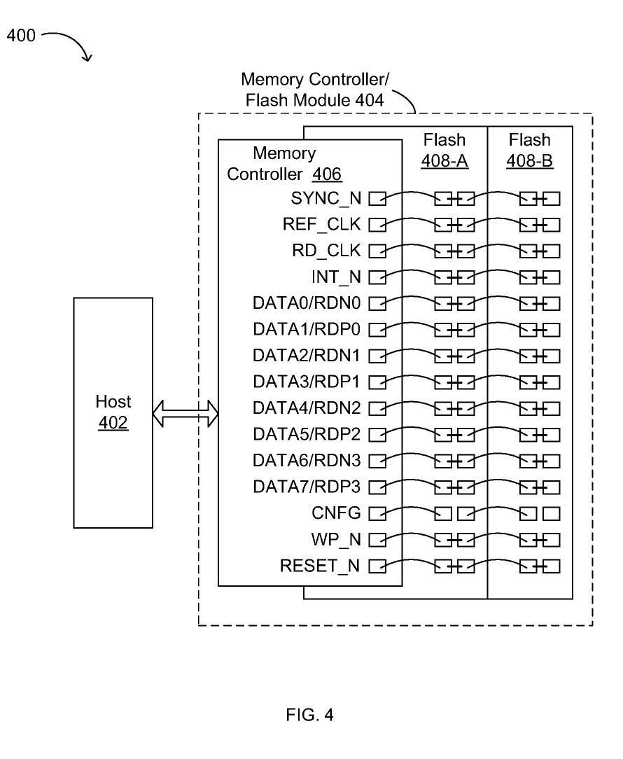

FIG. 3 shows an exemplary hybrid drive arrangement 300 suitable for use in accordance with embodiments of the present invention. Host 302 can interface with flash device 308 in hybrid drive 304. In general, the flash device 308 comprises controller/flash memory module 404 (see FIG. 4 and the discussion thereof below). Referring back to FIG. 3, in various examples, the interface between host 302 and flash 308 can include a serial advanced technology attachment (SATA) interface or a parallel ATA (PATA) interface. Hybrid drive 304 can also include central processing unit (CPU) 310, read channel 312, and buffer memory (e.g., dynamic random access memory (DRAM)) 306. For example, CPU 310 may comprise a conventional microprocessor, (digital) signal processor (e.g., a DSP), or microcontroller. Read channel 312 may comprise conventional read channel data transfer processing blocks (e.g., one or more ports, signal detectors, encoders, decoders, interleavers, de-interleavers, error checking code [ECC] calculators and/or comparators, etc.). DRAM 306 can include from about 2 Mb to about 8 Mb of memory. The present flash memory/controller module in particular embodiments can be utilized in hybrid drive 304, or in any suitable solid-state drive (SSD). Advantages of using flash memory in a hard drive, as opposed to a hard disk approach, include: (i) faster boot and resume times; (ii) longer battery life (e.g., for wireless applications); and (iii) higher data reliability.

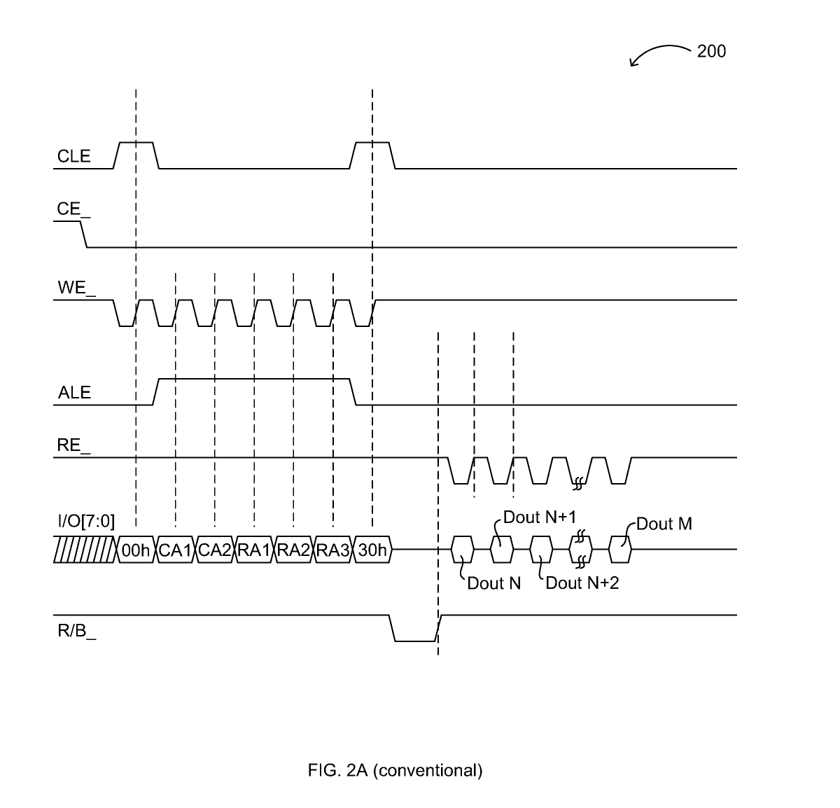

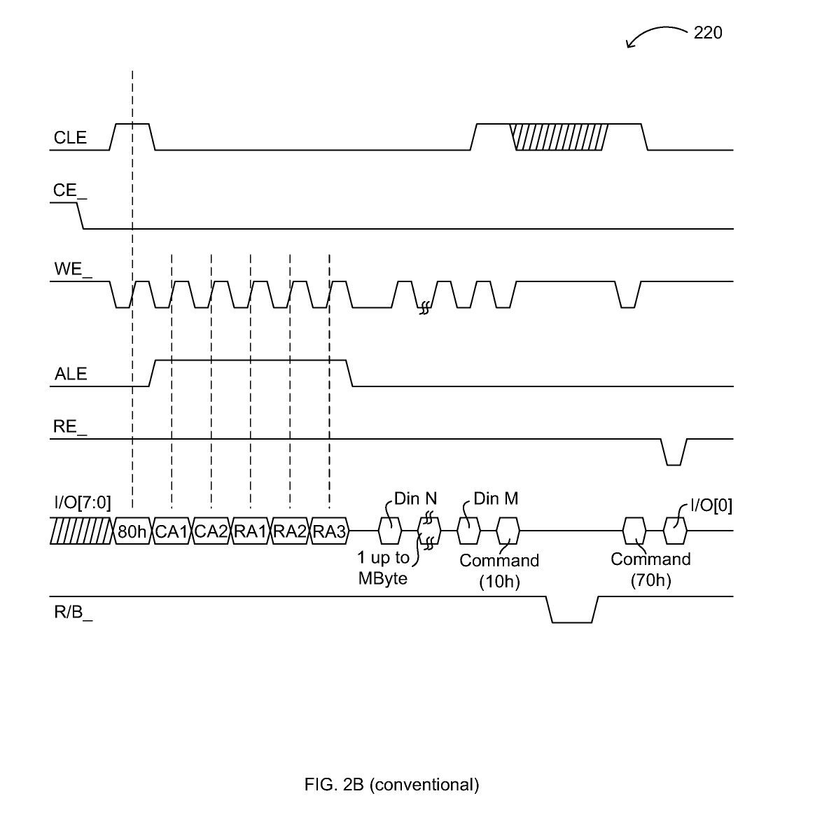

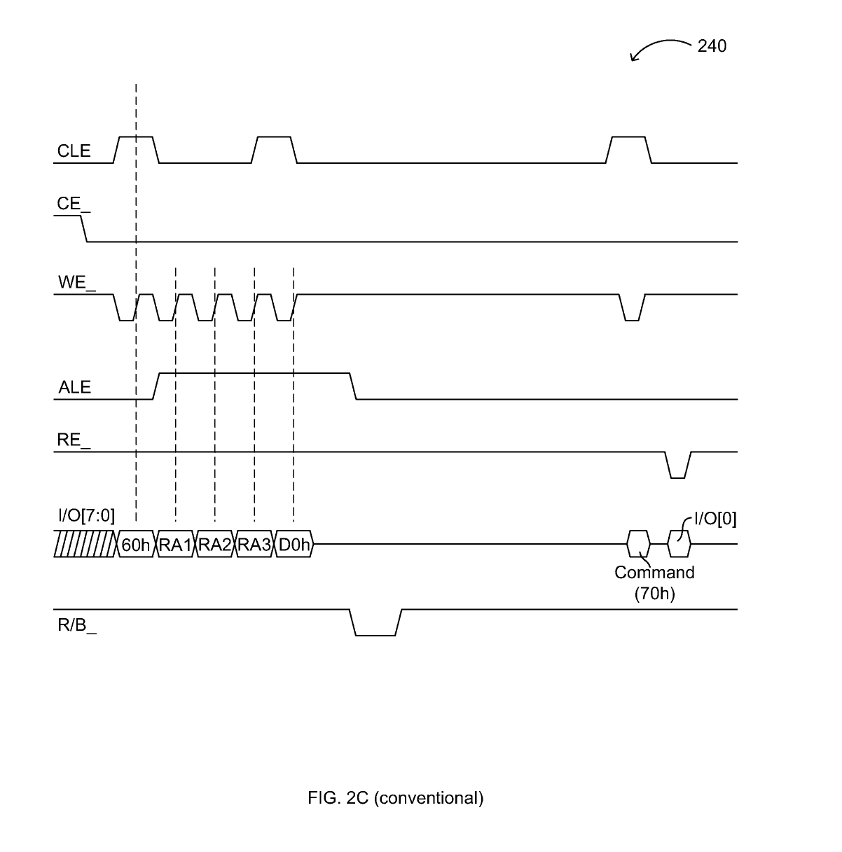

FIG. 4 shows an exemplary signal connection arrangement 400 in accordance with embodiments of the present invention. Host 402 can interface with memory controller/flash module 404. The interface between host 402 and memory controller 406 can be conventional (e.g., including pins and/or terminals for the signals shown in FIGS. 2A-2C and/or Table 1 above, or a subset thereof). Memory controller 406 can be connected with a plurality of flash memory devices (e.g., flash memory chip 408-A and flash memory chip 408-B) via each signal pin or terminal, as shown. In some embodiments, memory controller 406 may be implemented as an application specific integrated circuit (ASIC) or a system on a chip (SOC). In addition, signal CNFG may connect through circuitry on flash devices 408-A and 408-B in serial fashion. Table 3 below shows a pin or terminal description for signals in the interface between controller 406 and flash memory devices 408-A and 408-B in accordance with embodiments of the present invention (e.g., see the column labeled “Memory Controller”), as related to a conventional NAND flash interface. “In/Out” refers to whether the signal is an input signal, an output signal, or both, on the controller 406.

TABLE 3

| | Memory | | |
|---|---|---|---|
| NAND Flash | Controller | In/Out | Description |
| Data in/out | DATA[7:0] | In/Out | Input/Output 8-bit data |
| I/O[7:0] | | | |
| Command latch | SYNC_N | Out | Command timing signal |
| enable CLE | | | |
| Address latch enable | REF_CLK | Out | Clock for flash IP block |
| ALE | | | |
| Chip enable | | | |
| CE_{—} | | | |
| Read enable | RD_CLK | In | Sampling clock for Read |
| RE_{—} | | | Data CH0-CH3; capture |
| | | | clock for data byte |
| Write enable | CNFG | Out | Chip configuration |
| WE_{—} | | | |
| Write protect | WP_N | Out | Write protect |
| WP_{—} | | | |
| Ready/busy output | INT_N | In | Interrupt for PRG/ERASE |
| R/B_{—} | | OD | commands; pull-up for |
| | | | memory controller |
| RESET_N | RESET_N | Out | |

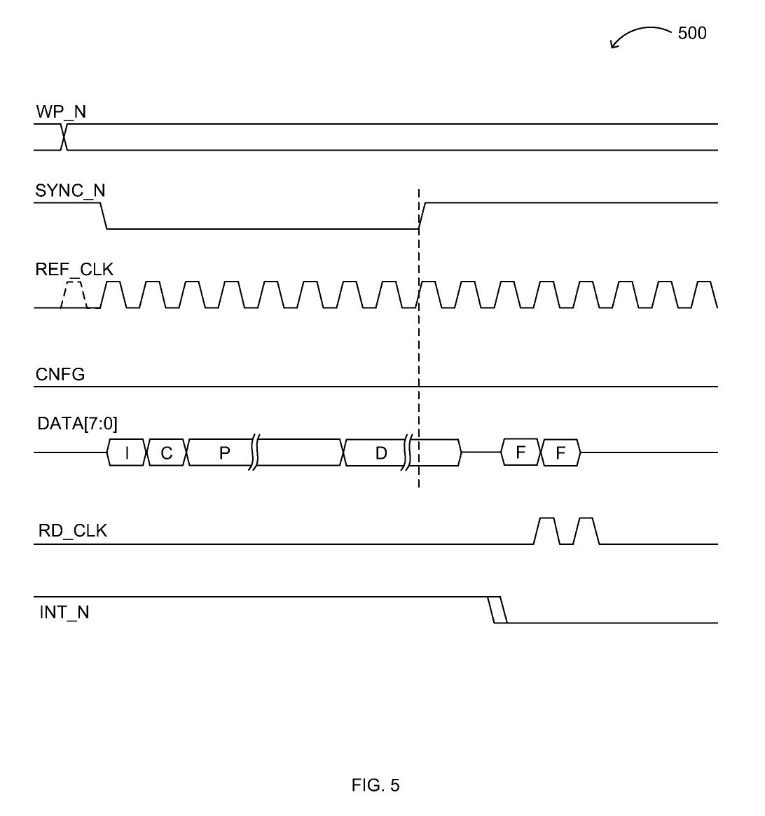

FIG. 5 shows a timing diagram 500 for an exemplary command sequence in accordance with embodiments of the present invention. From a memory controller, write protection (WP_N), command timing signal (SYNC_N), clock for flash (REF_CLK), and chip configuration (CNFG), can be supplied. Command timing signal SYNC_N may be brought high one cycle prior to tri-stating of the data bus. From a flash, a sampling clock for read data or a capture clock for a data byte (RD_CLK), and an interrupt for PRG/ERASE commands (INT_N), can be supplied. From either a memory controller or a flash, input/output data (DATA[7:0]) can be provided.

In the example of FIG. 5, SYNC_N can represent a timing signal to start the command sequence. Once appropriately configured, three signals may be of primary need for flash device control (e.g., SYNC_N, REF_CLK, and RD_CLK). On the DATA[7:0] pins, “I” can represent a flash identification (ID), “C” can represent a command byte, “P” can represent a parameter, “D” can represent a data byte from the memory controller, and “F” can represent flash data bytes or analog read data from flash devices. Further, command bytes may generally follow ID bytes to designate the flash memory device to which the particular command pertains. Also, broadcasting to each flash device coupled to the memory controller can be accommodated via a designated ID byte. Example command bytes can be as shown below in Table 4, where each “x” is independently a hexadecimal value assigned to that particular command.

TABLE 4

| Command byte | Command |
|---|---|
| xxh | PROGRAM |
| xxh | WRITE BUFFER |
| xxh | EXECUTE PROGRAM |
| xxh | READ |
| xxh | READ BUFFER |
| xxh | READ STATUS |
| xxh | READ ID |
| xxh | DEVICE CONFIG |
| xxh | SET CONFIG |
| xxh | READ ERROR INFO |
| xxh | ERASE |
| xxh | RESET |

Parameter bytes may generally follow command bytes, and a total number of parameter bytes may be dependent on the particular associated command. Data bytes may then generally follow parameter bytes, and a total number of data bytes may also be defined by the particular associated command. Further, data bytes may typically provide data for PROGRAM or WRITE BUFFER commands. Flash data bytes (i.e., those driven by a flash memory device) may generally be followed by either a command byte or a parameter byte, and a total number of flash data bytes may be defined by a particular associated command. Further, flash data bytes may typically be data for READ BUFFER, READ DATA, READ STATUS, READ ID, or SEND READ DATA commands.

A RESET command can instruct the controller/flash memory module (e.g., module 404 of FIG. 4) to abort a command and/or reset an associated (or identified) flash memory device. An example command description for a command or instruction to configure a flash ID (e.g., a DEVICE CONFIG command) is shown below in Table 5.

TABLE 5

| | | | | | | | | |
|---|---|---|---|---|---|---|---|---|
| symbol | B7 | B6 | B5 | B4 | B3 | B2 | B1 | B0 |

| | |
|---|---|
| I | xxh (broadcast) only |
| C | xxh (DEVICE CONFIG) |
| P(P1-Pn) | Authentication bytes |

A READ ID command can verify an authentication byte, a product code, and a flash memory device or chip revision, for example. An exemplary description for a verification command or instruction (e.g., READ ID) is shown below in Table 6.

TABLE 6

| | | | | | | | | |
|---|---|---|---|---|---|---|---|---|
| Symbol | B7 | B6 | B5 | B4 | B3 | B2 | B1 | B0 |

| | |
|---|---|
| I | Flash ID |
| C | xxh (READ ID) |
| F1 | Product code |
| F2 | Flash chip revision |
| F3 | Authentication byte |

A SET CONFIG command can enable and/or disable interrupts, and configure a number of bits per cell, for example. An exemplary description for an interrupt enable or cell configuration command or instruction (e.g., SET CONFIG) is shown below in Table 7.

TABLE 7

| | | | | | | | | |
|---|---|---|---|---|---|---|---|---|
| symbol | B7 | B6 | B5 | B4 | B3 | B2 | B1 | B0 |

| I | Flash ID or xxh (broadcast) | | | | | |
|---|---|---|---|---|---|---|
| C | xxh (SET CONFIG) | | | | | |
| P1 | D16 | MLC | EN_P | IEN_E | IEN_P | IEN_R |

D16: ‘1’ = 16-bit data bus; ‘0’ = 8-bit data bus;
MLC: set a number of bits per cell;
EN_P: ‘1’ = enable packing of programming data;
IEN_E: ‘1’ = enable interrupt when ERASE operation
completed;
IEN_P: ‘1’ = enable interrupt when PROGRAM completed;
IEN_R: ‘1’ = enable interrupt when READ data is ready

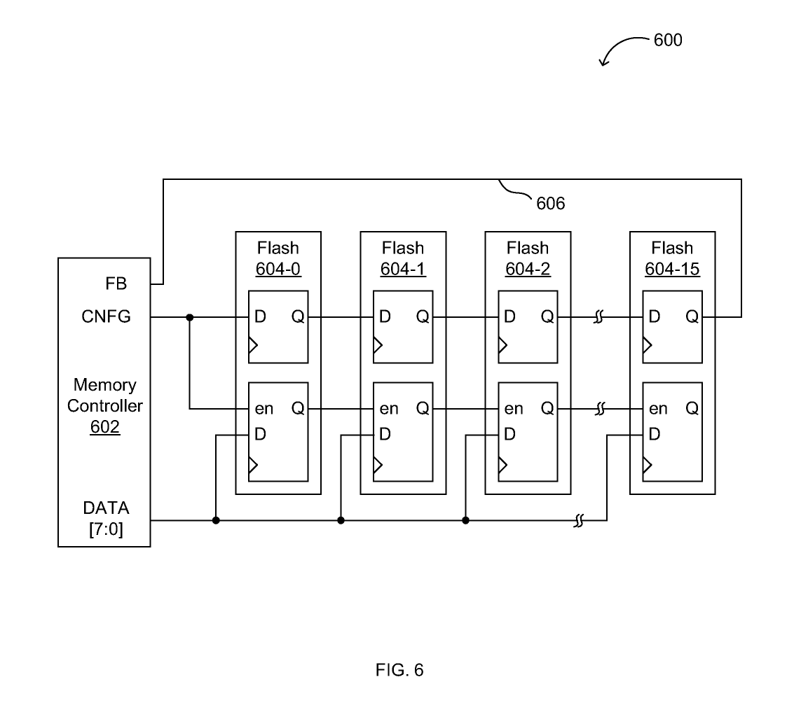

FIG. 6 shows a block diagram 600 for an exemplary flash memory chip and memory controller arrangement in accordance with embodiments of the present invention. For example, arrangement 600 or a variation with any number of flash memory devices may form a memory module. In the particular example of FIG. 6, memory controller 602 can interface with serially-coupled flash memory devices or chips 604-0, 604-1, 604-2, . . . 604-15, for example. CNFG in memory controller 602 can connect to a “D” input of one flip-flop, and an enable input of another flip-flop in flash 604-0 as shown. Also as shown, flip-flop outputs can be connected in serial fashion, and DATA[7:0] from memory controller 602 can connect to “D” flip-flop inputs.

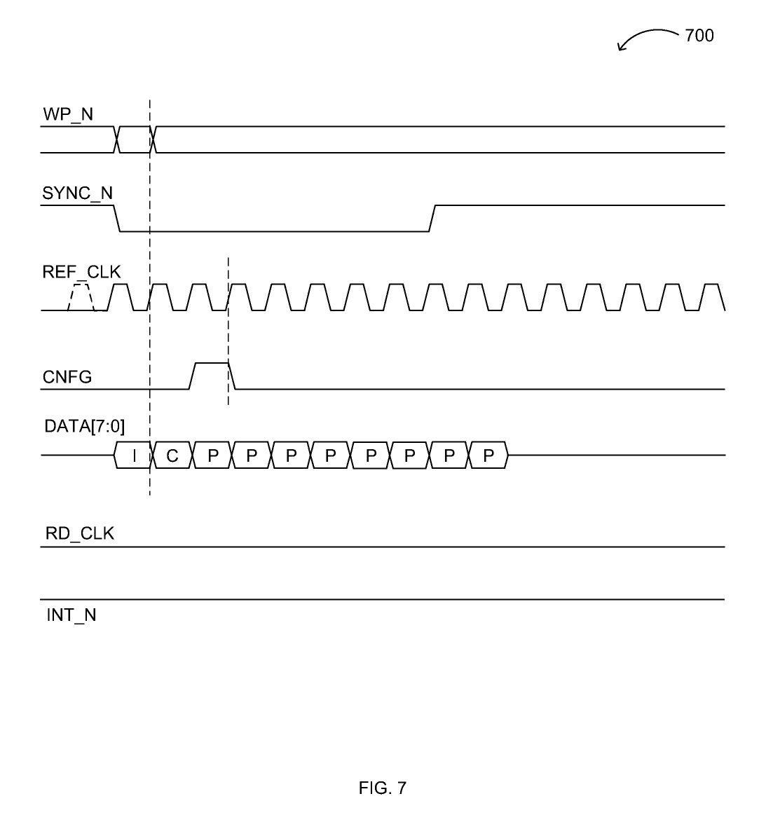

A scan chain or serial coupling arrangement can thus be formed, with feedback 606 connected to FB in memory controller 602. CNFG can be passed through the chain and returned via feedback 606. Further, each flip-flop can be clocked by REF_CLK (not shown in FIG. 6, but discussed below with reference to FIG. 7) for providing time-shifted versions of the configuration signal to subsequent flash memory devices in the chain. Thus, a number of REF_CLK cycles occurring before the CNFG pulse is returned to memory controller 602 can be used to determine the number of flash devices in a particular arrangement or memory module. Also, if reconfiguration is needed, a reset operation (e.g., using signal RESET_N, shown in FIG. 4) can first be performed.

FIG. 7 shows a timing diagram 700 for an exemplary device configuration operation in accordance with embodiments of the present invention. Upon a transition of the write protect and/or synchronization signal(s) to an asserted state, the flash device identification byte (e.g., a flash ID or “I” byte) and the command byte (e.g., a “C” byte) are transmitted from the controller to the flash memory devices. Authentication data “P” can be provided once CNFG transitions (e.g., goes to a “high” binary logic state) for a cycle after the flash ID byte and the command byte have been supplied, as shown. Also, synchronization (or command timing) signal SYNC_N can transition (e.g., go to a “high” binary logic state) one cycle prior to the last authentication data portion. In some embodiments, such authentication data portions can be provided for up to 16 REF_CLK cycles. Further, a device configuration command (e.g., command A0h) may be ignored by a particular flash memory device if: (i) the particular device has already been configured; (ii) the write protect signal is not asserted (e.g., WP_N=‘0’); (iii) the configuration signal (e.g., CNFG) has not been asserted; and/or (iv) the configuration signal has been asserted for two or more clock periods, or two separate times.

For configuration of each flash memory device in a system, the “I” byte can be a broadcast command such that the subsequent device configuration command can be received in each device in preparation for storing a device ID, as well as other configuration information. Each flash device ID can be stored in a reserved memory portion within each flash memory device. Further, each device can derive its own ID by counting the number of clock cycles between the assertion of the device configuration command and reception of a time-shifted version of the configuration signal at a given flash memory device. For example, flash memory device 604-0 can assign itself flash ID “0000” because the CFNG signal is asserted one cycle after the device configuration command is issued. Flash memory device 604-1 can then assign itself an ID of “0001” because of the two cycle difference between the device configuration command and the time-shifted version of the configuration signal reaching 604-1 (one cycle later than the signal reaches device 604-0), and so on. Alternatively, the parametric data bytes can simply provide the ID for each flash memory device from the memory controller.

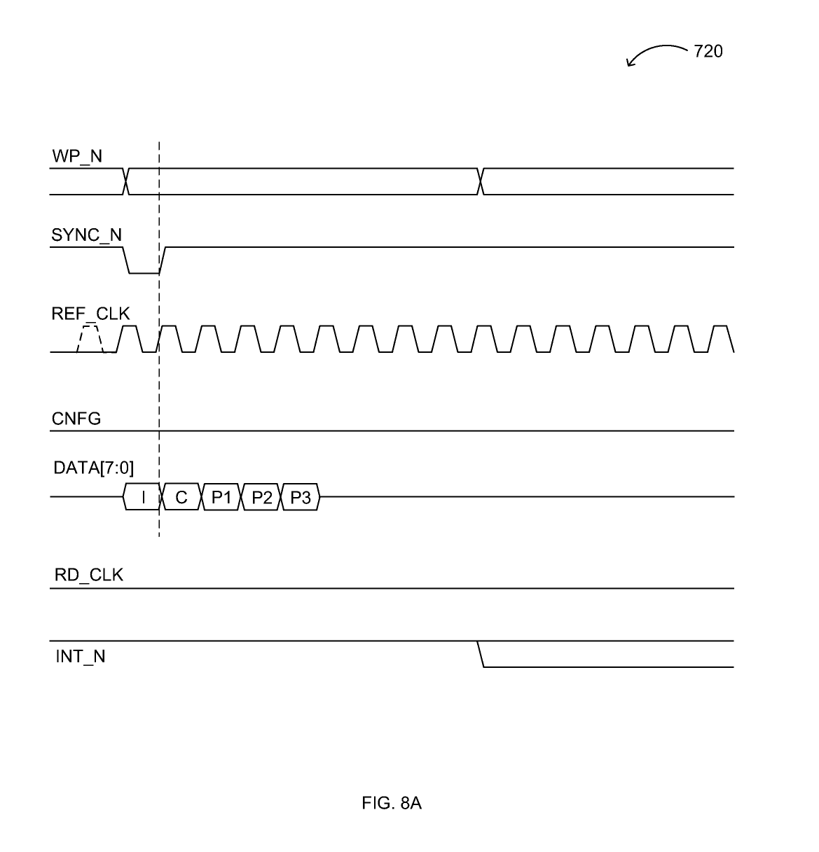

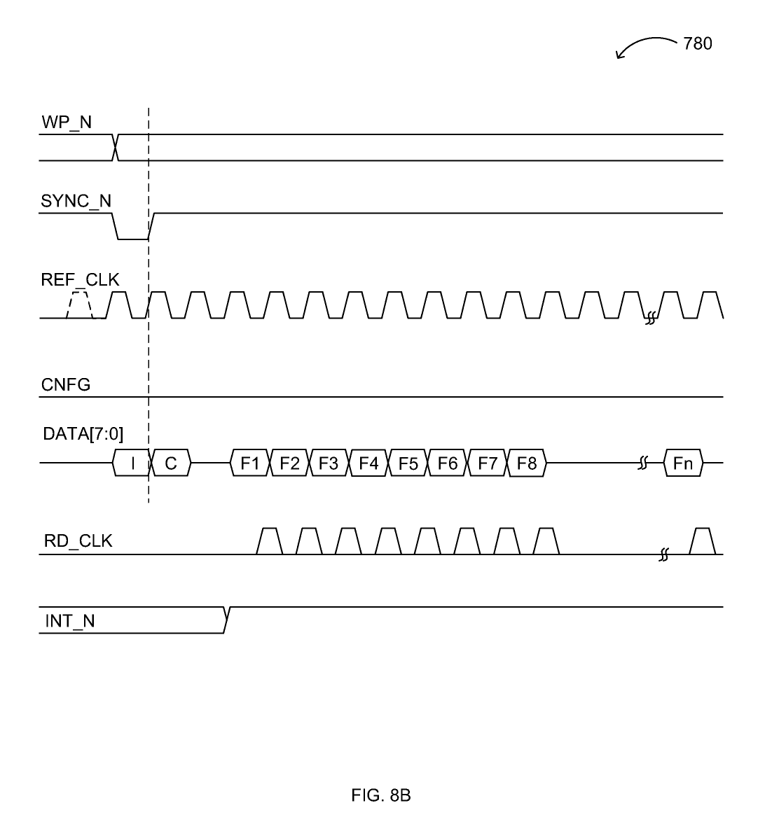

FIG. 8A shows a timing diagram 720 for an exemplary operation to erase data in one of the plurality of flash memory devices in accordance with embodiments of the present invention. To execute the erase operation, the write protect signal (e.g., WP_N) may be asserted for substantially the entire operation, but the synchronization signal (e.g., SYNC_N) may be asserted for a limited number of cycles of the timing signal (e.g., a single cycle of REF_CLK). The erase command (e.g., D0h) can be supplied, followed in subsequent cycles by parameter bytes P1, P2, and P3. Further, erase interrupt (INT_N) can be supplied by the particular flash device indicated by flash identification byte “I” supplied prior to the command byte “C”, and INT_N may go low to indicate completion of the erase operation (e.g., when IEN_E=‘1’).

FIG. 8B shows a timing diagram 780 for an exemplary operation to send buffer data to host for a buffer read in accordance with embodiments of the present invention. To execute the read buffer operation, the write protect signal (e.g., WP_N) may be asserted for the entire operation, but the synchronization signal (e.g., SYNC_N) may be asserted for a limited number of cycles of the timing signal (e.g., a single cycle of REF_CLK). The read buffer command (e.g., 32h) can be supplied, followed one cycle later by flash data bytes F1, F2, . . . Fn. Flash data bytes (F1-Fn) may be provided on analog outputs RDP0/RDN0-RDP3/RDN3 (8-bit bus), or RDP0/RDN0-RDP7/RDN7 (16-bit bus). To synchronize these data bytes, the read timing signal (e.g., RD_CLK) can be supplied from the particular flash device indicated by flash identification byte “I” supplied prior to the command byte “C”. Also, INT_N can be low when IEN_R=‘1’ to enable interrupt when read data is ready.

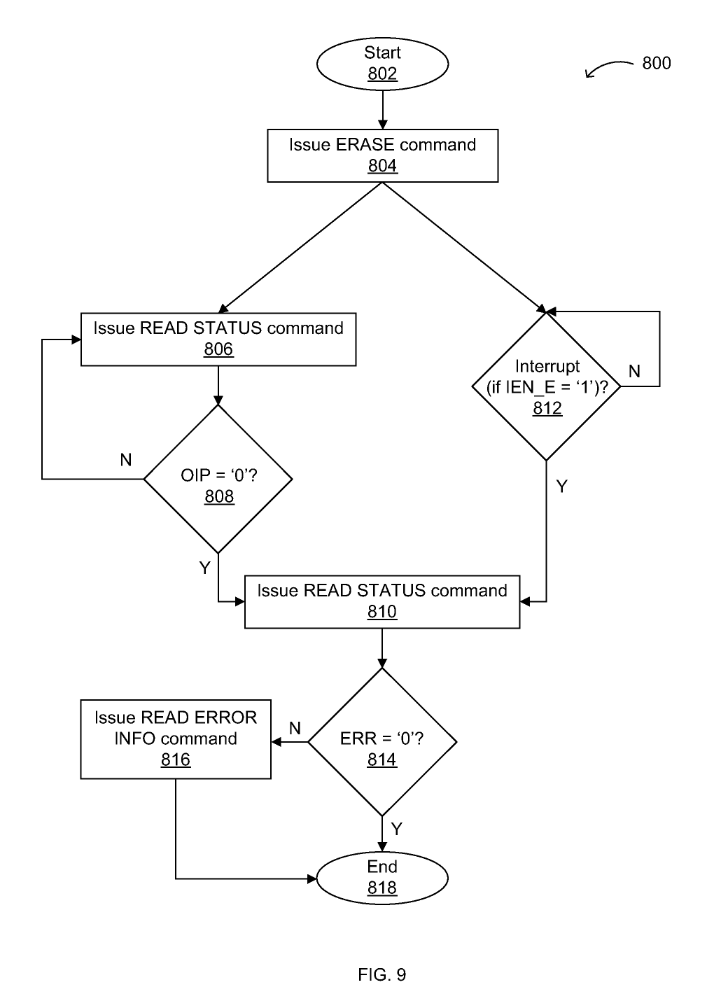

FIG. 9 shows a flow diagram 800 for an exemplary method of erasing in accordance with embodiments of the present invention. The flow can begin (802), and an erase command may be issued by or from the controller (804). For example, the erase command may execute a data erase operation. A read status command may then be issued by or from the controller (806), and may continue until an “operation in progress” (OIP) indicator is de-asserted (e.g., OIP=‘0,’ 808). The read status command generally determines the status of a (previous) command, such as an erase command, a program command, or a read command. The status of such commands may include no error, command execution in progress, and/or one or more errors or error types, depending on the number of bits available for providing read status information. When the OIP indicator is de-asserted (808) and/or an interrupt occurs (812), a second read status command may be issued (810). When the operation is complete and no error occurs, a “no error” status may be indicated. Alternatively, the second read status command (810) may either clear or assert an interrupt, depending on whether an error occurred during the operation (e.g., command execution). If an error is found (e.g., by asserting an error indicator or flag, step 814), a read error information command may be issued (816) to get error information, and the flow can complete (818). If no error is found (ERR=‘0’ in 814), the flow can complete (818).

Exemplary Systems Using the Present Circuit

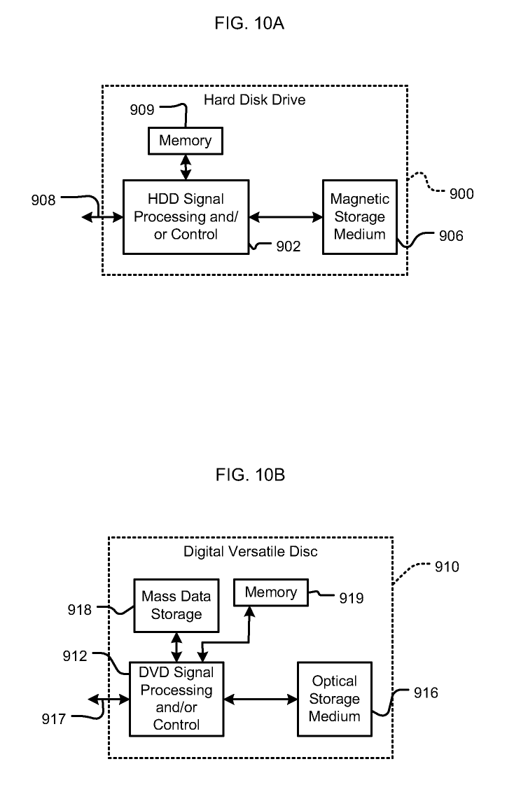

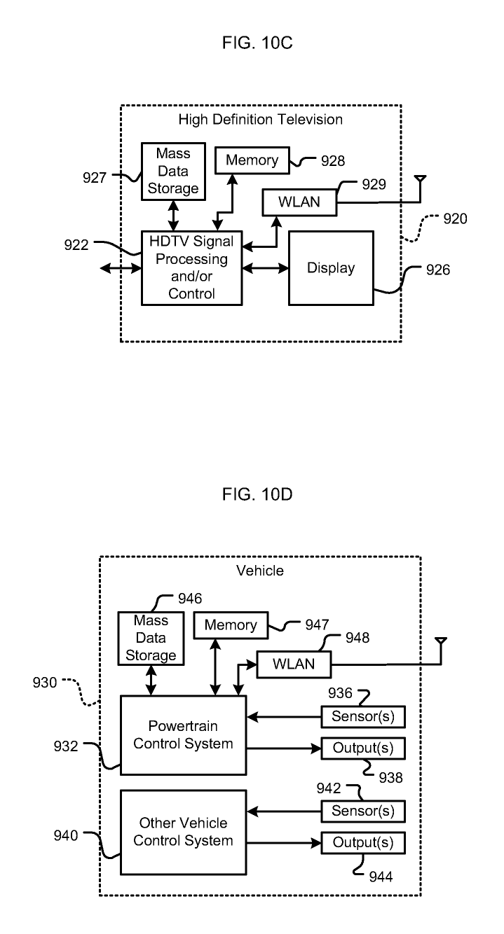

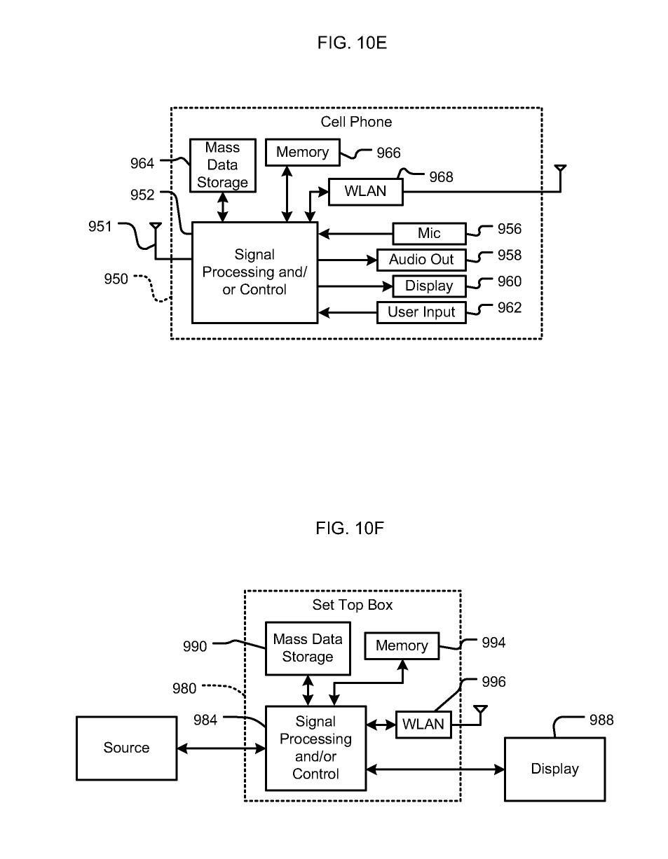

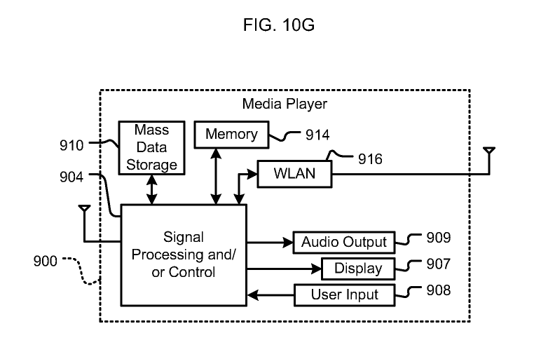

In a further aspect of the invention, a system may comprise the present apparatus or circuit for controlling flash memory devices. Various exemplary implementations of the present invention are shown in FIGS. 10A-10G.

Referring now to FIG. 10A, the present invention can be implemented in a hard disk drive (HDD) 900. The present invention may implement either or both signal processing and/or control circuits, which are generally identified in FIG. 10A at 902. In some implementations, the signal processing and/or control circuit 902 and/or other circuits (not shown) in the HDD 900 may process data, perform coding and/or encryption, perform calculations, and/or format data that is output to and/or received from a magnetic storage medium 906.

The HDD 900 may communicate with a host device (not shown) such as a computer, mobile computing devices such as personal digital assistants, cellular phones, media or MP3 players and the like, and/or other devices via one or more wired or wireless communication links 908. The HDD 900 may be connected to memory 909 such as random access memory (RAM), low latency nonvolatile memory such as flash memory, read only memory (ROM) and/or other suitable electronic data storage.

Referring now to FIG. 10B, the present invention can be implemented in a digital versatile disc (DVD) drive 910. The present invention may implement either or both signal processing and/or control circuits, which are generally identified in FIG. 10B at 912, and/or mass data storage 918 of the DVD drive 910. The signal processing and/or control circuit 912 and/or other circuits (not shown) in the DVD 910 may process data, perform coding and/or encryption, perform calculations, and/or format data that is read from and/or data written to an optical storage medium 916. In some implementations, the signal processing and/or control circuit 912 and/or other circuits (not shown) in the DVD 910 can also perform other functions such as encoding and/or decoding and/or any other signal processing functions associated with a DVD drive.

The DVD drive 910 may communicate with an output device (not shown) such as a computer, television or other device via one or more wired or wireless communication links 917. The DVD 910 may communicate with mass data storage 918 that stores data in a nonvolatile manner. The mass data storage 918 may include a hard disk drive (HDD). The HDD may have the configuration shown in FIG. 10A. The HDD may be a mini HDD that includes one or more platters having a diameter that is smaller than approximately 1.8″. The DVD 910 may be connected to memory 919 such as RAM, ROM, low latency nonvolatile memory such as flash memory and/or other suitable electronic data storage.

Referring now to FIG. 10C, the present invention can be implemented in a high definition television (HDTV) 920. The present invention may implement either or both signal processing and/or control circuits, which are generally identified in FIG. 10C at 922, a WLAN interface and/or mass data storage of the HDTV 920. The HDTV 920 receives HDTV input signals in either a wired or wireless format and generates HDTV output signals for a display 926. In some implementations, signal processing circuit and/or control circuit 922 and/or other circuits (not shown) of the HDTV 920 may process data, perform coding and/or encryption, perform calculations, format data and/or perform any other type of HDTV processing that may be required.

The HDTV 920 may communicate with mass data storage 927 that stores data in a nonvolatile manner such as optical and/or magnetic storage devices. At least one HDD may have the configuration shown in FIG. 10A and/or at least one DVD may have the configuration shown in FIG. 10B. The HDD may be a mini HDD that includes one or more platters having a diameter that is smaller than approximately 1.8″. The HDTV 920 may be connected to memory 928 such as RAM, ROM, low latency nonvolatile memory such as flash memory and/or other suitable electronic data storage. The HDTV 920 also may support connections with a WLAN via a WLAN network interface 929.

Referring now to FIG. 10D, the present invention can be implemented in a control system of a vehicle 930, a WLAN interface and/or mass data storage of the vehicle control system. In some implementations, the present invention implement a powertrain control system 932 that receives inputs from one or more sensors such as temperature sensors, pressure sensors, rotational sensors, airflow sensors and/or any other suitable sensors and/or that generates one or more output control signals such as engine operating parameters, transmission operating parameters, and/or other control signals.

The present invention may also be implemented in other control systems 940 of the vehicle 930. The control system 940 may likewise receive signals from input sensors 942 and/or output control signals to one or more output devices 944. In some implementations, the control system 940 may be part of an anti-lock braking system (ABS), a navigation system, a telematics system, a vehicle telematics system, a lane departure system, an adaptive cruise control system, a vehicle entertainment system such as a stereo, DVD, compact disc and the like. Still other implementations are contemplated.

The powertrain control system 932 may communicate with mass data storage 946 that stores data in a nonvolatile manner. The mass data storage 946 may include optical and/or magnetic storage devices (for example, hard disk drives [HDDs] and/or DVDs). At least one HDD may have the configuration shown in FIG. 10A and/or at least one DVD may have the configuration shown in FIG. 10B. The HDD may be a mini HDD that includes one or more platters having a diameter that is smaller than approximately 1.8″. The powertrain control system 932 may be connected to memory 947 such as RAM, ROM, low latency nonvolatile memory such as flash memory and/or other suitable electronic data storage. The powertrain control system 932 also may support connections with a WLAN via a WLAN network interface 948. The control system 940 may also include mass data storage, memory and/or a WLAN interface (all not shown).

Referring now to FIG. 10E, the present invention can be implemented in a cellular phone 950 that may include a cellular antenna 951. The present invention may implement either or both signal processing and/or control circuits, which are generally identified in FIG. 10E at 952, a WLAN interface and/or mass data storage of the cellular phone 950. In some implementations, the cellular phone 950 includes a microphone 956, an audio output 958 such as a speaker and/or audio output jack, a display 960 and/or an input device 962 such as a keypad, pointing device, voice actuation and/or other input device. The signal processing and/or control circuits 952 and/or other circuits (not shown) in the cellular phone 950 may process data, perform coding and/or encryption, perform calculations, format data and/or perform other cellular phone functions.

The cellular phone 950 may communicate with mass data storage 964 that stores data in a nonvolatile manner such as optical and/or magnetic storage devices (for example, hard disk drives [HDDs] and/or DVDs). At least one HDD may have the configuration shown in FIG. 10A and/or at least one DVD may have the configuration shown in FIG. 10B. The HDD may be a mini HDD that includes one or more platters having a diameter that is smaller than approximately 1.8″. The cellular phone 950 may be connected to memory 966 such as RAM, ROM, low latency nonvolatile memory such as flash memory and/or other suitable electronic data storage. The cellular phone 950 also may support connections with a WLAN via a WLAN network interface 968.

Referring now to FIG. 10F, the present invention can be implemented in a set top box 980. The present invention may implement either or both signal processing and/or control circuits, which are generally identified in FIG. 10F at 984, a WLAN interface and/or mass data storage of the set top box 980. The set top box 980 receives signals from a source such as a broadband source and outputs standard and/or high definition audio/video signals suitable for a display 988 such as a television and/or monitor and/or other video and/or audio output devices. The signal processing and/or control circuits 984 and/or other circuits (not shown) of the set top box 980 may process data, perform coding and/or encryption, perform calculations, format data and/or perform any other set top box function.

The set top box 980 may communicate with mass data storage 990 that stores data in a nonvolatile manner. The mass data storage 990 may include optical and/or magnetic storage devices (for example, hard disk drives [HDDs] and/or DVDs). At least one HDD may have the configuration shown in FIG. 10A and/or at least one DVD may have the configuration shown in FIG. 10B. The HDD may be a mini HDD that includes one or more platters having a diameter that is smaller than approximately 1.8″. The set top box 980 may be connected to memory 994 such as RAM, ROM, low latency nonvolatile memory such as flash memory and/or other suitable electronic data storage. The set top box 980 also may support connections with a WLAN via a WLAN network interface 996.

Referring now to FIG. 10G, the present invention can be implemented in a media player 1000. The present invention may implement either or both signal processing and/or control circuits, which are generally identified in FIG. 10G at 1004, a WLAN interface and/or mass data storage of the media player 1000. In some implementations, the media player 1000 includes a display 1007 and/or a user input 1008 such as a keypad, touchpad and the like. In some implementations, the media player 1000 may employ a graphical user interface (GUI) that typically employs menus, drop down menus, icons and/or a point-and-click interface via the display 1007 and/or user input 1008. The media player 1000 further includes an audio output 1009 such as a speaker and/or audio output jack. The signal processing and/or control circuits 1004 and/or other circuits (not shown) of the media player 1000 may process data, perform coding and/or encryption, perform calculations, format data and/or perform any other media player function.

The media player 1000 may communicate with mass data storage 1010 that stores data such as compressed audio and/or video content in a nonvolatile manner. In some implementations, the compressed audio files include files that are compliant with MP3 format or other suitable compressed audio and/or video formats. The mass data storage may include optical and/or magnetic storage devices (for example, hard disk drives [HDDs] and/or DVDs). At least one HDD may have the configuration shown in FIG. 10A and/or at least one DVD may have the configuration shown in FIG. 10B. The HDD may be a mini HDD that includes one or more platters having a diameter that is smaller than approximately 1.8″. The media player 1000 may be connected to memory 1014 such as RAM, ROM, low latency nonvolatile memory such as flash memory and/or other suitable electronic data storage. The media player 1000 also may support connections with a WLAN via a WLAN network interface 1016. Still other implementations in addition to those described above are contemplated.

### CONCLUSION

Thus, the present invention provides an interface, arrangement, and method for configuring and operating flash memory devices in multiple device systems without increasing a pin count. In particular, embodiments of the present invention provide multiple flash memory systems including a memory controller, as well as methods of configuring and operating flash memory devices in such a system.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of configuring a multi-device memory system, comprising:
asserting a control signal to a plurality of flash memory devices, each flash memory device having:
a plurality of parallel input and/or output (I/O) terminals, including one or more data I/O terminals, a clock terminal configured to receive a clock signal, and a write protect terminal configured to receive a write protection signal; and
a serially connected control terminal configured to receive said control signal;
determining a unique identifier for each of said plurality of flash memory devices; and
serially storing said unique identifier in a corresponding one of said plurality of flash memory devices within a predetermined number of clock cycles of asserting said control signal.

2. The method of claim 1, wherein said control signal is a configuration control signal, and said configuration control signal is asserted when it has a predetermined state or undergoes a predetermined transition.

3. The method of claim 1, wherein said control signal is asserted for a predetermined number of clock cycles.

4. The method of claim 3, further comprising:
time-shifting said control signal using said clock signal in a first flash memory device, and providing a shifted control signal to a second flash memory device adjacent to said first flash memory device.

5. The method of claim 4, further comprising providing parametric data to each of said plurality of flash memory devices via said data I/O terminal(s).

6. The method of claim 5, further comprising registering said parametric data for each of said plurality of flash memory devices using said clock signal.

7. The method of claim 4, wherein said determining said unique identifier comprises counting a number of clock cycles between a first command and a time-shifted version of said configuration signal.

8. The method of claim 7, wherein said first command comprises a device configuration command.

9. The method of claim 1, comprising ignoring an assertion of said control signal in one of said flash memory devices when:
said one of said flash memory devices has stored said unique identifier without being reset;
said write protection signal is asserted; and/or
said control signal is asserted for a predetermined number of clock cycles, said predetermined number being greater than one.

10. The method of claim 2, further comprising determining a number of said plurality of flash memory devices using a time-shifted version of said configuration control signal from a last of said plurality of flash memory devices.

11. The method of claim 1, wherein said unique identifier comprises a multi-bit binary string.

12. A method of operating a multi-device memory system, comprising:
asserting one or more control signals on a corresponding number of serially-connected input/output (I/O) terminals on each of a plurality of flash memory devices in said system, each of said flash memory devices further comprising one or more parallel data I/O terminals and a clock terminal;
identifying one of said plurality of flash memory devices by transmitting a unique identifier on said parallel data I/O terminal(s) within a predetermined number of clock cycles of asserting said control signal(s); and
transmitting an instruction to said identified one of said plurality of flash memory devices on said data I/O terminal(s).

13. The method of claim 12, wherein said instruction comprises a read, erase, or program command.

14. The method of claim 12, wherein said identifying comprises supplying a device identification byte on said data I/O terminals.

15. The method of claim 14, wherein said device identification byte is supplied in a cycle of a clock signal prior to said transmitting said instruction, said clock signal being supplied on said clock terminal.

16. The method of claim 14, further comprising synchronizing a result of said instruction using a read sampling clock coupled to each of said plurality of flash memory devices.

17. The method of claim 12, wherein said transmitting said instruction comprises using an interface coupling a memory controller to said plurality of flash memory devices, said interface comprising:
a configuration terminal for transmitting a configuration signal to a first of said plurality of flash memory devices;
a command control terminal for transmitting a command timing signal to said plurality of flash memory devices; and
a read clock terminal for receiving a read sampling clock from one of said plurality of flash memory devices.

18. A memory module, comprising:
a first flash memory device configured to receive a configuration signal from a memory controller and to generate a first registered signal from said configuration signal;
a second flash memory device configured to receive said first registered signal, and to generate a second registered signal from said first registered signal, said second registered signal being provided to said memory controller, and
said memory controller coupled to said first and second flash memory devices via an interface, said interface comprising:
a control terminal configured to transmit said configuration signal, and
a plurality of parallel input/output (I/O) terminals coupled to each of said first and second flash memory devices, said plurality of parallel I/O terminals including one or more data I/O terminals configured to transmit data signals, a clock terminal configured to receive a clock signal, and a write protect terminal configured to receive a write protection signal.

19. The memory module of claim 18, wherein said first and second registered signals are configured to serially shift a pulse of said configuration signal from said first to said second flash memory device, and then to said memory controller.

20. The memory module of claim 18, wherein each of said first and second flash memory devices comprises a first D-type flip-flop configured to provide said first and second registered signals, respectively.

21. The memory module of claim 20, wherein each of said first and second flash memory device comprises a second D-type flip-flop configured to register parametric data when enabled by a corresponding one of said first and second registered signals, said parametric data being provided on said data I/O terminals.

22. The memory module of claim 21, wherein said parametric data comprises a unique identifier.

23. The memory module of claim 19, further comprising counting logic, said counting logic being configured to compute a unique identifier from a number of clocks between a device configuration command and a corresponding one of said first and second registered signals.

24. The memory module of claim 19, wherein said data I/O terminals comprise at least eight bits.

25. The memory module of claim 19, wherein said controller further comprises:
configuration logic configured to transmit said configuration signal to said first flash memory device;
command control logic configured to transmit a command timing signal to said first and second flash memory devices;
timing logic configured to transmit a clock signal to said first and second flash memory devices; and
a read clock terminal configured to receive a read sampling clock from one of said plurality of flash memory devices.
